(19) United States
(12) Patent Application Publication
(10) Pub. No.: US 2026/0175166 A1
(43) Pub. Date: Jun. 25, 2026

(54) LIQUID CHROMATOGRAPHY-MASS SPECTROMETRY SYSTEM

(71) Applicant: SHENZHEN MINDRAY BIO-MEDICAL ELECTRONICS CO., LTD., Shenzhen (CN)

(72) Inventors: Yongfeng WU, Shenzhen (CN); Hai LIU, Shenzhen (CN)

(73) Assignee: SHENZHEN MINDRAY BIO-MEDICAL ELECTRONICS CO., LTD., Shenzhen (CN)

(21) Appl. No.: 19/431,114

(22) Filed: Dec. 23, 2025

(30) Foreign Application Priority Data
Dec. 25, 2024 (CN) 202411955833.3

(51) Int. Cl. B01D 53/30; B01D 15/08; B01D 53/00; B01D 53/14; B01D 53/18; G01N 30/06; G01N 30/72; G01N 30/84

(52) U.S. Cl. CPC B01D 53/30; B01D 15/08; B01D 53/002; B01D 53/1406; B01D 53/18; G01N 30/06; G01N 30/7233; G01N 30/84; B01D 2259/45; G01N 2030/067

(57) ABSTRACT

The invention relates to a liquid chromatography-mass spectrometry system including: a pretreatment module configured to pretreat a test sample; a liquid chromatography module configured to elute the pretreated test sample; a mass spectrometry module configured to perform mass spectrometry on the eluted test sample; a waste gas treatment module in fluid communication with at least one of the pretreatment module, the liquid chromatography module and the mass spectrometry module and configured to perform liquefaction and absorption of volatile waste gas in gas to be treated that is generated by the module(s) in fluid communication with the waste gas treatment module; and a control module configured to generate a waste gas treatment instruction based on waste gas-related information and to control the waste gas treatment module to initiate waste gas treatment on the gas to be treated in response to the waste gas treatment instruction.

### CROSS-REFERENCE TO RELATED APPLICATION

The present application claims benefit of Chinese Application No. 202411955833.3, filed on Dec. 25, 2024, the contents of which are hereby incorporated by reference in its entirety.

### TECHNICAL FIELD

The disclosure relates to the technical field of medical devices, and in particular to a liquid chromatography-mass spectrometry system.

### BACKGROUND

Some medical devices require large quantities of organic reagents such as methanol and acetonitrile. These organic substances have low boiling points (for example, methanol has a boiling point of 64.5° C. at normal pressure) and are highly volatile. In medical devices using methanol, the concentration of methanol volatile gas in the air may exceed the allowable standards in various countries (for example, 50 mg/m³ in China), which will have an impact on the health of laboratory personnel. If the concentration of methanol in the air is too high, there may even be a risk of explosion.

Current medical devices either directly discharge the highly volatile organic reagents mentioned above without treatment, leading to environmental pollution and certain health risks, or requires installation in modified clinical laboratories, resulting in cumbersome operations and high costs.

### SUMMARY

In order to avoid at least some of the disadvantages in the prior art, an embodiment of the disclosure provides a liquid chromatography-mass spectrometry system capable of automatically initiating the treatment of a volatile waste gas.

According to the disclosure, a liquid chromatography-mass spectrometry system is provided. The liquid chromatography-mass spectrometry system includes:
a pretreatment module configured to pretreat a test sample using a pretreatment reagent;
a liquid chromatography module configured to elute the pretreated test sample using an eluent;
a mass spectrometry module configured to perform mass spectrometry on the eluted test sample, at least one of the pretreatment module, the liquid chromatography module and the mass spectrometry module being arranged in a housing;
a waste gas treatment module, at least a portion of the waste gas treatment module being arranged in the housing, and the waste gas treatment module being in fluid communication with at least one of the pretreatment module, the liquid chromatography module and the mass spectrometry module and being configured to perform liquefaction and absorption of a volatile waste gas in a gas to be treated that is generated by at least one of the pretreatment reagent, the eluent and the eluted test sample; and
a control module configured to generate a waste gas treatment instruction based on waste gas-related information and to control the waste gas treatment module to initiate waste gas treatment on the gas to be treated in response to the waste gas treatment instruction, so as to discharge the treated gas from the liquid chromatography-mass spectrometry system.

In some embodiments, the liquid chromatography-mass spectrometry system further includes a first waste gas concentration measurement component configured to measure a first waste gas concentration of the gas to be treated; and
the control module is further configured to obtain the first waste gas concentration as the waste gas-related information and to generate the waste gas treatment instruction when the first waste gas concentration is greater than a first preset concentration.

In some embodiments, the control module is further configured to obtain a sample test volume of the liquid chromatography-mass spectrometry system as the waste gas-related information and to generate the waste gas treatment instruction when the sample test volume is greater than a preset test volume.

In some embodiments, the liquid chromatography-mass spectrometry system further includes:
a second waste gas concentration measurement component arranged downstream of the waste gas treatment module and configured to measure a second waste gas concentration of the treated gas;
where the control module is further configured to control the waste gas treatment module to discharge the treated gas when the second waste gas concentration is not greater than a second preset concentration.

In some embodiments, the control module is further configured to control the waste gas treatment module to perform re-liquefaction and re-absorption of the volatile waste gas in the treated gas when the second waste gas concentration is greater than the second preset concentration.

In some embodiments, the waste gas treatment module includes:
an aspiration assembly in fluid communication with at least one of the pretreatment module, the liquid chromatography module and the mass spectrometry module and configured to aspirate the gas to be treated that is generated by the module(s) in fluid communication with the aspiration assembly;
a waste gas treatment assembly arranged downstream of the aspiration assembly and configured to perform liquefaction and absorption of the volatile waste gas in the aspirated gas to be treated to generate a waste liquid, the waste gas treatment assembly including a first waste gas absorption component and a second waste gas absorption component, the second waste gas absorption component being arranged downstream of the first waste gas absorption component; and
a waste liquid discharge assembly configured to discharge the waste liquid.

In some embodiments, the first waste gas absorption component and the second waste gas absorption component each include one of an atomizer, a condenser and a spray tower, the atomizer being configured to generate atomized droplets for absorbing the waste gas, the condenser being configured to condense droplets in the gas, and the spray tower being configured to provide spray droplets for absorbing the waste gas and generating the waste liquid.

In some embodiments, the first waste gas absorption component is an atomizer, and the second waste gas absorption component is a condenser; or
both the first waste gas absorption component and the second waste gas absorption component are spray towers.

In some embodiments, the waste gas treatment assembly further includes a third waste gas absorption component, the third waste gas absorption component being arranged downstream of the second waste gas absorption component, and the third waste gas absorption component being one of a condenser, a spray tower and a waste gas adsorption chamber.

In some embodiments, the waste gas treatment assembly further includes a fourth waste gas absorption component, the fourth waste gas absorption component being arranged downstream of the third waste gas absorption component, and the fourth waste gas absorption component being a waste gas adsorption chamber.

In some embodiments, the first waste gas absorption component is the atomizer, the second waste gas absorption component is the condenser, the third waste gas absorption component is the spray tower, and the fourth waste gas absorption component is provided with activated carbon. The waste liquid discharge assembly includes a discharge line, a waste liquid pump, and a waste liquid cell, the discharge line being configured to enable the waste liquid pump to be in fluid communication with the condenser and the spray tower, the waste liquid pump being configured to aspirate a waste liquid generated by the condenser and the spray tower via the discharge line, and the waste liquid cell being configured to store the waste liquid aspirated by the waste liquid pump.

In some embodiments, the waste gas treatment assembly includes at least one atomizer or spray tower; and
the liquid chromatography-mass spectrometry system further includes a water supply device configured to at least supply water to the atomizer or the spray tower.

In some embodiments, the waste gas treatment assembly includes at least one spray tower, where the water supply device is configured to at least supply water to the spray tower and includes:
a water supply source configured to supply the water;
a water supply line that provides fluid communication between the water supply source and the spray tower, a first switching component and a water pump being provided on the water supply line, the first switching component being configured to control ON and OFF of the water supply line, and the water pump being located downstream of the first switching component and configured to aspirate the water supplied by the water supply source to the spray tower through the water supply line; and
a circulating water line, one end of the circulating water line being in fluid communication with the water supply line between the first switching component and the water pump, the other end of the circulating water line being in fluid communication with the spray tower, a second switching component being provided on the circulating water line, and the second switching component being configured to control ON and OFF of the circulating water line.

In some embodiments, the liquid chromatography-mass spectrometry system further includes:
a bypass line arranged downstream of the aspiration assembly and upstream of a vent port of the liquid chromatography-mass spectrometry system, the vent port being configured to discharge the aspirated gas to be treated or the gas treated by the waste gas treatment module; and
a third switching component configured to switch between a first state, in which the aspiration assembly is connected to the waste gas treatment assembly and is disconnected from the bypass line, and a second state, in which the aspiration assembly is connected to the bypass line and is disconnected from the waste gas treatment assembly.

In some embodiments, the liquid chromatography-mass spectrometry system further includes:
a first waste gas concentration measurement component configured to measure a first waste gas concentration of the gas to be treated so as to determine whether the third switching component is to switch to the first state or the second state, where the third switching component is configured to switch to the first state when the first waste gas concentration is greater than a first preset concentration, and to switch to the second state when the first waste gas concentration is not greater than the first preset concentration.

In some embodiments, the aspiration assembly includes:
aspiration ports;
a filter component arranged downstream of the aspiration ports and configured to filter particulate matters in the gas to be treated; and
a fan arranged between the filter component and the waste gas treatment assembly configured to create a negative pressure for aspirating the gas to be treated.

In some embodiments, the aspiration ports include a first aspiration port, a second aspiration port, and a third aspiration port, the first aspiration port being in fluid communication with the pretreatment module, the second aspiration port being in fluid communication with the liquid chromatography module, and the third aspiration port being in fluid communication with the mass spectrometry module.

In some embodiments, the first aspiration port is arranged adjacent to at least one of a cleaning cell, a reagent disc and a waste box of the pretreatment module; and/or
the second aspiration port is arranged adjacent to at least one of a reaction cell and a cleaning cell of the liquid chromatography module; and/or
the third aspiration port is arranged at a vacuum exhaust outlet of the mass spectrometry module.

In some embodiments, the mass spectrometry module is arranged in the housing, and at least a portion of the waste gas treatment module, particularly the waste gas treatment assembly, is arranged in the housing.

In some embodiments, at least a portion of the waste gas treatment module, particularly the waste gas treatment assembly, is in fluid communication with at least one of the pretreatment module, the liquid chromatography module and the mass spectrometry module in modular manner.

Based on the above technical solutions, the liquid chromatography-mass spectrometry system according to the embodiments of the disclosure can automatically initiate the treatment of the volatile waste gas based on waste gas-related information, so as to promptly extract and treat the volatile waste gas generated in the system, avoiding health hazards of waste gas, such as methanol, to laboratory personnel, thereby improving the automation level and use safety of the liquid chromatography-mass spectrometry system.

### BRIEF DESCRIPTION OF THE DRAWINGS

The drawings illustrated herein are intended to provide a further understanding of the disclosure and form a part hereof, and exemplary embodiments of the disclosure and the description thereof are intended to explain the disclosure and are not to be construed as unduly limiting the disclosure. In the figures:

FIG. 1 is a schematic diagram of the composition of modules of a liquid chromatography-mass spectrometry system according to some embodiments of the disclosure.

FIG. 2 is a schematic control flowchart of a liquid chromatography-mass spectrometry system according to some embodiments of the disclosure.

FIG. 3 is a schematic diagram of the composition of a waste gas treatment module of a liquid chromatography-mass spectrometry system according to some embodiments of the disclosure.

FIG. 4 is a schematic diagram of the composition of a waste gas treatment module of a liquid chromatography-mass spectrometry system according to some other embodiments of the disclosure.

FIG. 5 is a schematic diagram of the composition of a spray tower of a waste gas treatment module of a liquid chromatography-mass spectrometry system according to some embodiments of the disclosure.

### LIST OF REFERENCE NUMERALS

1: aspiration assembly; 10: aspiration port; 11: first aspiration port; 12: second aspiration port; 13: third aspiration port; 2: waste gas treatment assembly; 21: first waste gas absorption component; 22: second waste gas absorption component; 23: third waste gas absorption component; 24: fourth waste gas absorption component; 3: vent port; 4: waste liquid discharge assembly; 41: discharge line; 42: waste liquid pump; 43: waste liquid cell; 5: water supply device; 50: water supply source; 51: water supply line; 511: first switching component; 512: water pump; 52: circulating water line; 522: second switching component; 6: bypass line; 63: third switching component; 71: first waste gas concentration measurement component; 72: second waste gas concentration measurement component; 73: vent valve; 74: fourth switching component; 81: filter component; 82: fan; 83: flow regulation component; 9: reprocessing line; 101: atomizer; 102: condenser; 103: spray tower; 104: activated carbon; 130: tower body; 131: first opening; 132: second opening; 133: third opening; 134: fourth opening; 135: fifth opening; 100: pretreatment module; 200: liquid chromatography module; 300: mass spectrometry module; 400: waste gas treatment module; 500: control module.

### DETAILED DESCRIPTION

Various exemplary embodiments of the disclosure will be described in detail with reference to the drawings. The description of the exemplary embodiments is merely illustrative and is in no way construed as limiting the disclosure and the application or use thereof. The disclosure may be implemented in various forms, without being limited to the embodiments described herein. These embodiments are provided to make the disclosure thorough and complete and to enable those skilled in the art to fully understand the scope of the disclosure. It should be noted that unless specifically stated otherwise, the relative arrangement of components and steps set forth in these embodiments, the composition of materials, numerical expressions, and numerical values should be construed as merely for illustration rather than limitation.

The terms “first”, “second” and the like used in the disclosure do not denote any order, quantity or importance, but are merely used to distinguish different parts. The term such as “comprise” or “include” means that the elements preceding the term encompass the elements listed after the term and do not exclude the possibility of encompassing other elements. The terms such as “top”, “bottom”, “left” and “right” are used merely to denote relative positional relationships. When the absolute position of the described object changes, the relative positional relationship may also change accordingly.

In the disclosure, when it is described that a particular device is located between a first device and a second device, there may be or may not be an intermediate device between the particular device and the first device or the second device. When it is described that a particular device is connected to a further device, the particular device may be directly connected to the further device without an intervening device, or may not be directly connected to the further device so that an intervening device is provided.

Unless specifically defined otherwise, all terms used in the disclosure (including technical or scientific terms) have the same meaning as understood by those of ordinary skill in the art to which the disclosure belongs. It should also be understood that terms defined in such as general dictionaries should be interpreted as having meanings consistent with their meanings in the context of the relevant technology, rather than being interpreted with idealized or extremely formalized sense, unless explicitly defined herein.

The techniques, methods, and equipment known to those of ordinary skill in the relevant art may not be discussed in detail, but where appropriate, the techniques, methods and equipment shall be considered as part of the specification.

Based on the embodiments of the disclosure described above, in the absence of explicit negation or conflict, the technical features of one of the embodiments may be advantageously combined with one or more other embodiments.

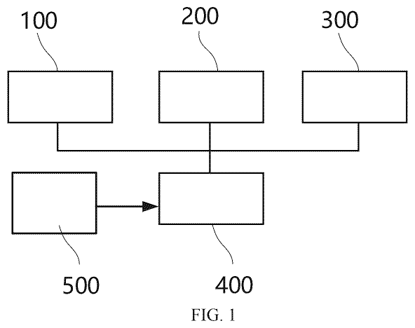

The disclosure proposes a liquid chromatography-mass spectrometry system, as shown in FIG. 1, including a pretreatment module 100, a liquid chromatography module 200, a mass spectrometry module 300, a waste gas treatment module 400, and a control module 500.

The pretreatment module 100 is configured to pretreat a test sample using a pretreatment reagent, for example, to perform pretreatment based on magnetic beads and a cleaning liquid.

The liquid chromatography module 200 is configured to elute the pretreated test sample using an eluent. For example, the liquid chromatography module 200 includes at least one chromatographic column.

The mass spectrometry module 300 is configured to perform mass spectrometry on the eluted test sample. The mass spectrometry module 300 may be, for example, a triple multi-pole mass spectrometer, such as a triple quadrupole mass spectrometer.

At least one of the pretreatment module 100, the liquid chromatography module 200 and the mass spectrometry module 300 is arranged in a housing.

At least a portion of the waste gas treatment module 400 is arranged in the housing. The waste gas treatment module 400 is in fluid communication with at least one of the pretreatment module 100, the liquid chromatography module 200 and the mass spectrometry module 300, and is configured to perform liquefaction and absorption of the volatile waste gas in the gas to be treated that is generated by at least one of the pretreatment reagent, the eluent and the eluted test sample in the module in fluid communication with the waste gas treatment module. Optionally, the volatile waste gas may be volatile organic waste gas, such as methanol and acetonitrile. In some of the following embodiments, methanol is used as an example for illustration.

The control module 500 is configured to generate a waste gas treatment instruction based on waste gas-related information and to control the waste gas treatment module 400 to initiate waste gas treatment on the gas to be treated in response to the waste gas treatment instruction, so as to discharge the treated gas from the liquid chromatography-mass spectrometry system. Here, the control module 500 is communicatively connected to the waste gas treatment module 400 to control the waste gas treatment of the waste gas treatment module 400.

The liquid chromatography-mass spectrometry system of this embodiment can automatically initiate the treatment of volatile waste gas based on waste gas-related information, avoiding health hazards of waste gas, such as methanol, to laboratory personnel, which eliminates the need for manual initiation of waste gas treatment, thereby improving the automation level and use safety of the liquid chromatography-mass spectrometry system.

In the embodiments of the disclosure, the control module 500 may be implemented in the form of software and/or hardware.

In some embodiments, the control module 500 may be integrated in the form of software into a controller of at least one of the pretreatment module 100, the liquid chromatography module 200 and the mass spectrometry module 300.

In some other embodiments, the control module 500 may be implemented in the form of hardware, such as a processor or a computer-readable storage medium. For example, the control module 500 may include a non-transitory computer-readable storage medium storing computer-readable instructions and one or more processors. Processors include, but are not limited to, a central processing unit (CPU), a micro controller unit (MCU), a field-programmable gate array (FPGA), a digital signal processor (DSP), and other devices for interpreting computer instructions and processing data in computer software.

In the embodiments of the disclosure, the waste gas-related information indicates whether to initiate waste gas treatment, and may be derived from a waste gas detection component or from a preset waste gas treatment rule.

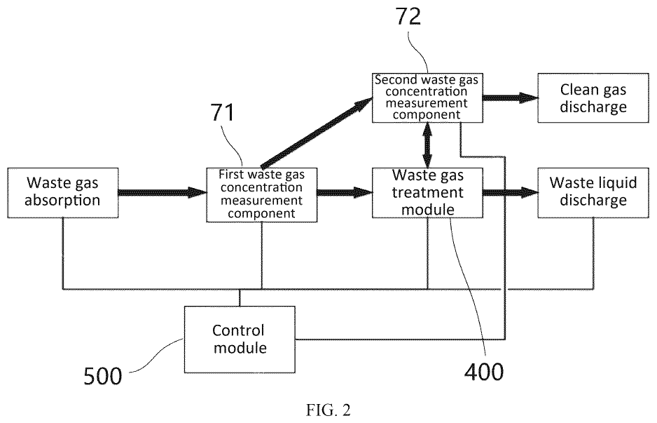

In some embodiments, the waste gas-related information is derived from a waste gas detection component. As shown in FIG. 2, the liquid chromatography-mass spectrometry system further includes a first waste gas concentration measurement component 71 configured to measure a first waste gas concentration of the gas to be treated. Here, the control module 500 is further configured to obtain the first waste gas concentration as the waste gas-related information and to generate the waste gas treatment instruction when the first waste gas concentration is greater than a first preset concentration.

For example, the first preset concentration may be set to a national standard threshold (e.g., 50 mg/m³) or less than the national standard threshold. When the first waste gas concentration does not meet the national standard, the control module 500 automatically generates a waste gas treatment instruction to control the waste gas treatment module 400 to absorb and treat the waste gas.

Optionally, when the first waste gas concentration is not greater than the first preset concentration, the gas to be treated may bypass the waste gas treatment module 400 and be directly discharged, thereby reducing energy consumption and reducing the usage cost of the liquid chromatography-mass spectrometry system.

Optionally, the first waste gas concentration measurement component 71 may be a waste gas concentration sensor, such as a methanol concentration sensor.

Optionally, the first waste gas concentration measurement component 71 may be arranged in any one of the pretreatment module 100, the liquid chromatography module 200, the mass spectrometry module 300 and the waste gas treatment module 400. For example, the first waste gas concentration measurement component 71 may be arranged in the waste gas treatment module 400.

In some other embodiments, the waste gas-related information is derived from a preset waste gas treatment rule. That is, the control module 500 automatically generates a waste gas treatment instruction based on the preset waste gas treatment rule to control the waste gas treatment module 400 to absorb and treat the waste gas.

In some implementations, the waste gas-related information may include a sample test volume of the liquid chromatography-mass spectrometry system. That is, the control module 500 is further configured to obtain the sample test volume of the liquid chromatography-mass spectrometry system as the waste gas-related information and to generate the waste gas treatment instruction when the sample test volume is greater than a preset test volume.

In other words, the preset waste gas treatment rule includes the sample test volume of the liquid chromatography-mass spectrometry system being greater than the preset test volume.

In some other implementations, the waste gas-related information may include an operating duration of the liquid chromatography-mass spectrometry system, that is, the control module 500 is further configured to obtain the operating duration of the liquid chromatography-mass spectrometry system as the waste gas-related information and generate the waste gas treatment instruction when the operating duration exceeds a preset duration.

In other words, the preset waste gas treatment rule includes the operating duration of the liquid chromatography-mass spectrometry system being greater than the preset duration.

In still some other implementations, the control module 500 is further configured to obtain a preset waste gas treatment timing as the waste gas-related information and to generate the waste gas treatment instruction when the current time is consistent with the preset waste gas treatment timing.

In other words, the preset waste gas treatment rule includes reaching the preset waste gas treatment timing.

In some embodiments, as shown in FIG. 2, the liquid chromatography-mass spectrometry system further includes a second waste gas concentration measurement component 72. The second waste gas concentration measurement component 72 is arranged downstream of the waste gas treatment module 400 and is configured to measure a second waste gas concentration of the treated gas. Here, the control module 500 is further configured to control the waste gas treatment module 400 to discharge the treated gas when the second waste gas concentration is not greater than a second preset concentration.

Specifically, the second waste gas concentration measurement component 72 is arranged between the waste gas treatment module 400 and a clean gas discharge outlet. The second preset concentration may be set to a national standard threshold. The system discharges the treated gas only when the waste gas concentration meets the national standard, which can avoid environmental pollution by waste gas, thereby improving the use safety of the liquid chromatography-mass spectrometry system.

Optionally, the second preset concentration may be different from the first preset concentration or the same as the first preset concentration, for example, both are set to a national allowable emission standard threshold.

Optionally, the second waste gas concentration measurement component 72 may be a waste gas concentration sensor, such as a methanol concentration sensor.

In some embodiments, the control module 500 is further configured to control the waste gas treatment module 400 to perform re-liquefaction and re-absorption of the volatile waste gas in the treated gas when the second waste gas concentration is greater than the second preset concentration until the waste gas concentration meets the standard, thereby improving the use safety of the liquid chromatography-mass spectrometry system.

Next, some embodiments of the waste gas treatment module 400 of the disclosure will be described.

The inventors have also found in the research that most of current methanol waste gas treatment devices are large-scale industrial devices for removing and recovering methanol, some as high as ten meters, and small ones also have a size of more than several meters, which are difficult to be built into a medical device or placed outside an instrument for methanol absorption.

On this basis, the embodiments of the disclosure provide a low-cost and miniaturized waste gas treatment module 400, which can be simply mounted in the liquid chromatography-mass spectrometry system or simply connected to the liquid chromatography-mass spectrometry system.

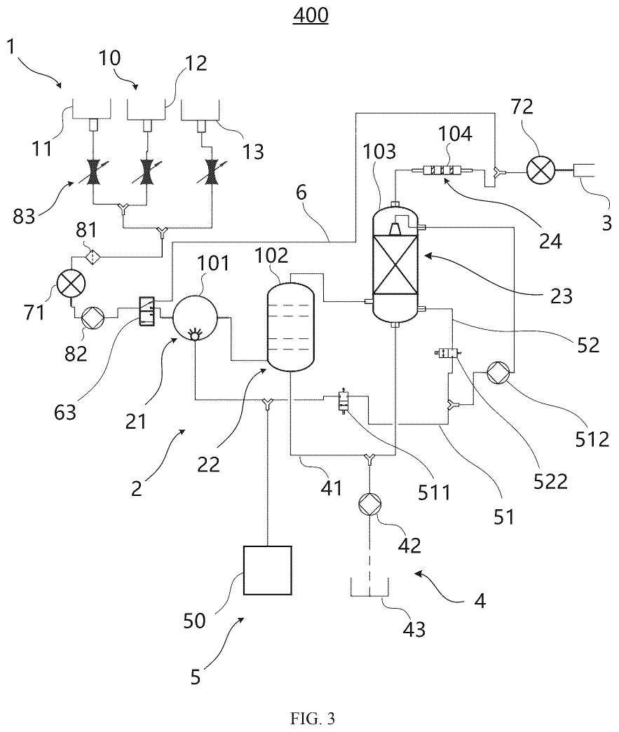

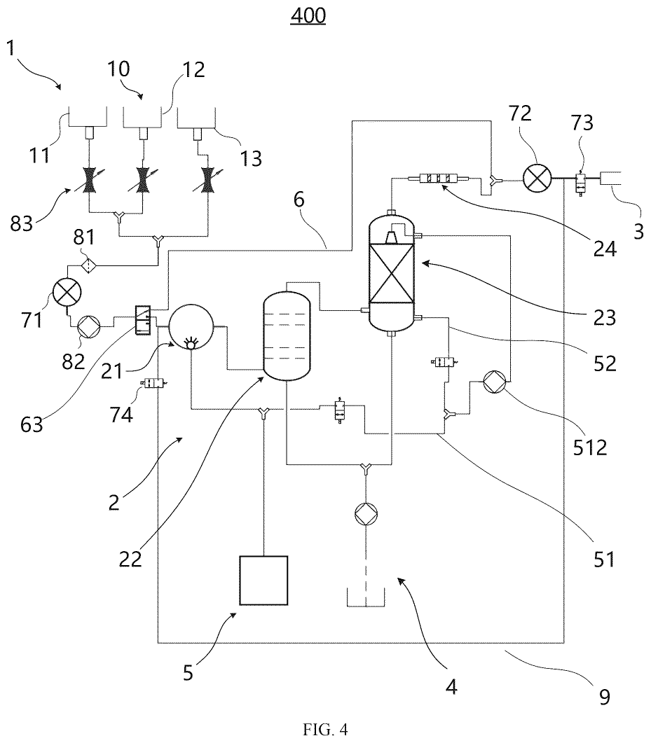

In some embodiments, as shown in FIGS. 3 and 4, the waste gas treatment module 400 includes: an aspiration assembly 1 in fluid communication with at least one of the pretreatment module 100, the liquid chromatography module 200 and the mass spectrometry module 300 and configured to aspirate the gas to be treated that is generated by the module(s) in fluid communication with the aspiration assembly; a waste gas treatment assembly 2 arranged downstream of the aspiration assembly 1 and configured to perform liquefaction and absorption of the volatile waste gas in the aspirated gas to be treated to generate a waste liquid, the waste gas treatment assembly 2 including a first waste gas absorption component 21 and a second waste gas absorption component 22, the second waste gas absorption component 22 being arranged downstream of the first waste gas absorption component 21; and a waste liquid discharge assembly 4 configured to discharge the waste liquid.

Specifically, the first waste gas absorption component 21 is configured for first-stage waste gas absorption, and the second waste gas absorption component 22 is configured for second-stage waste gas absorption. By setting two stages of waste gas absorption simultaneously, the volatile waste gas might be fully liquefied and absorbed to purify the gas to be treated. The waste gas treatment module 400 may be designed in a miniaturized manner, so that the waste gas treatment module 400 is built into other modules in fluid communication with the waste gas treatment module or a main portion of the waste gas treatment module 400 is placed outside other modules in fluid communication with the waste gas treatment module. This makes the waste gas treatment of the liquid chromatography-mass spectrometry system no longer limited to specific laboratory departments, and might reduce the production cost of equipment manufacturers and the usage cost of the laboratory departments.

Optionally, the aspiration assembly 1 includes aspiration ports 10. The aspiration ports 10 are in fluid communication with at least one of the pretreatment module 100, the liquid chromatography module 200 and the mass spectrometry module 300.

Optionally, when generating a waste gas treatment instruction based on the waste gas-related information, the control module 500 controls the first waste gas absorption component 21 and the second waste gas absorption component 22 to initiate waste gas treatment simultaneously, or first controls the first waste gas absorption component 21 to initiate waste gas treatment, and then controls the second waste gas absorption component 22 to initiate waste gas treatment within a period of time.

In some embodiments, as shown in FIGS. 3 and 4, the aspiration ports 10 include a first aspiration port 11, a second aspiration port 12, and a third aspiration port 13. The first aspiration port 11 is in fluid communication with the pretreatment module 100, the second aspiration port 12 is in fluid communication with the liquid chromatography module 200, and the third aspiration port 13 is in fluid communication with the mass spectrometry module 300.

Optionally, the aspiration ports 10 are arranged in a main waste gas volatilization region of the module in fluid communication with the aspiration ports to specifically improve the aspiration efficiency of the waste gas treatment module 400 for the volatile waste gas.

In some implementations, the first aspiration port 11 may be arranged adjacent to at least one of a cleaning cell, a reagent disc and a waste box of the pretreatment module 100.

In some alternative or additional implementations, the second aspiration port 12 may be arranged adjacent to at least one of a reaction cell and a cleaning cell of the liquid chromatography module 200.

In some other alternative or additional implementations, the third aspiration port 13 may be arranged at a vacuum exhaust outlet of the mass spectrometry module 300. For example, the third aspiration port 13 is arranged facing the vacuum exhaust outlet, so that after being drawn out through the vacuum exhaust outlet, the waste gas might be promptly aspirated by the aspiration assembly 1 through the third aspiration port 13 into the waste gas treatment assembly 2 for treatment.

By providing a plurality of aspiration ports all located in the volatile regions of the volatile waste gas of each module, multi-channel precise aspiration of the volatile waste gas of each module might be achieved, and the volatile waste gas may be treated promptly. This avoids aspiration after the volatile waste gas is mixed with other background gases in the system, which can effectively reduce the gas flow rate of the volatile waste gas, thereby improving the waste gas absorption and treatment efficiency.

Optionally, the waste liquid discharge assembly 4 may be in fluid communication with a medical waste liquid channel or the like.

Optionally, the waste gas treatment module 400 further includes a vent port 3 configured to discharge the gas treated by the waste gas treatment assembly 2, and the waste gas treatment assembly 2 provides fluid communication between the aspiration ports 10 and the vent port 3.

In some embodiments, as shown in FIGS. 3 and 4, the first waste gas absorption component 21 and the second waste gas absorption component 22 each include one of an atomizer 101, a condenser 102 and a spray tower 103. The atomizer 101 is configured to generate atomized droplets for absorbing waste gas, the condenser 102 is configured to condense droplets in the gas, and the spray tower 103 is configured to provide spray droplets for absorbing the waste gas and generating the waste liquid.

Specifically, the atomizer 101 is an atomization humidification chamber. The atomizer 101 may deliver a large number of small, atomized droplets into the methanol waste gas, and the small droplets are fully mixed with the methanol waste gas to absorb the methanol gas, which is beneficial to the miniaturization of the waste gas treatment module 400. Specifically, the spray tower 103 uses a small spray tower, and a spray water volume thereof is less than a preset value.

Optionally, the atomizer 101 may be an ultrasonic atomizer.

Optionally, the condenser 102 may use a shell-and-tube condenser or the like, and the condensation temperature of the condenser 102 may be set to 2-8° C. The condensed droplets are collected downward at the bottom of a condensation chamber via a cooling pipe.

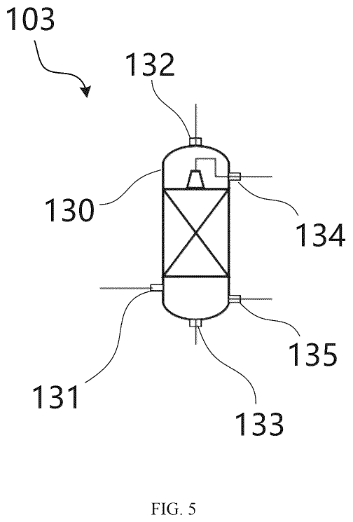

Optionally, as shown in FIG. 5, the spray tower 103 includes a tower body 130 and packing arranged in the tower body 130. The tower body 130 includes: a first opening 131 arranged below the tower body 130 for the gas to be treated to enter; a second opening 132 arranged in a top region of the tower body 130 for discharge of the gas in which the waste gas has been absorbed by spray water; a third opening 133 arranged in a bottom region of the tower body 130 for the spray water to be discharged; and a fourth opening 134 arranged above the tower body 130 for supplying spray water to the tower body 130.

In some embodiments, the tower body 130 further includes a fifth opening 135, different from the third opening 133, arranged in the bottom region of the tower body 130 for the spray water to be discharged.

In some embodiments, as shown in FIGS. 3 and 4, the first waste gas absorption component 21 is an atomizer 101, and the second waste gas absorption component 22 is a condenser 102.

Specifically, the atomizer 101 generates a large number of atomized droplets using pure water, and the atomized droplets are fully mixed and contact with the aspirated waste gas. During the process, the atomized droplets might quickly absorb the methanol gas; the gas mixed by atomization and humidification enters the condenser 102 promptly from the atomizer 101 to reduce the temperature. On the one hand, this can prevent the atomized droplets from evaporating rapidly into water vapor when encountering the waste gas and being unable to absorb methanol anymore. On the other hand, due to the humid air and low temperature in the condenser 102, the atomized droplets absorb the methanol gas while gradually condensing on a wall of a condensation line of the condenser 102, so that the methanol gas is collected into the waste liquid along with condensed water and discharged to the outside of the device via the waste liquid discharge assembly 4. By combining the atomizer 101 and the condenser 102 to perform liquefaction and absorption of the waste gas, which eliminates the need of an ultra-low temperature condenser, thereby achieving low cost and miniaturization of the waste gas treatment module 400 and facilitating the integration of the waste gas treatment assembly into the liquid chromatography-mass spectrometry system.

In some other alternative embodiments, both the first waste gas absorption component 21 and the second waste gas absorption component 22 are spray towers 103.

Specifically, the spray tower 103 uses small spray droplets to absorb methanol in the waste gas, which can reduce the waste gas concentration in the gas to be treated. The provision of double spraying ensure that the gas to be treated is fully purified to obtain a gas that meets the emission standard. In addition, the provision of two stages of spray towers can eliminate the need of a large spray tower, thereby achieving the low cost and miniaturization of the waste gas treatment module 400 and facilitating the integration of the waste gas treatment assembly into the liquid chromatography-mass spectrometry system.

Optionally, the first waste gas absorption component 21 is an atomizer 101, and the second waste gas absorption component 22 is a spray tower 103.

Optionally, the first waste gas absorption component 21 is a spray tower 103, and the second waste gas absorption component 22 is a condenser 102.

In some embodiments, as shown in FIGS. 3 and 4, the waste gas treatment assembly 2 further includes a third waste gas absorption component 23. The third waste gas absorption component 23 is arranged downstream of the second waste gas absorption component 22.

Specifically, the third waste gas absorption component 23 is configured for the third-stage waste gas absorption treatment. After the first two stages of waste gas absorption treatment, the waste gas concentration is significantly reduced. Then, the remaining volatile waste gas is absorbed by the third waste gas absorption component, which ensures that the waste gas meets the standard.

In this embodiment, the volatile waste gas in the gas to be treated is treated by means of three-stage waste gas absorption, which, compared with the arrangement of two-stage waste gas absorption, further ensures that the volatile waste gas is fully absorbed to avoid environmental pollution by waste gas; and it is beneficial to reduce the size of each waste gas absorption component to make full use of space, so as to meet the miniaturization requirement of the waste gas treatment module 400 and further reduce the production and usage costs of the liquid chromatography-mass spectrometry system.

In some embodiments, the third waste gas absorption component 23 is one of a condenser 102, a spray tower 103 and a waste gas adsorption chamber.

In some embodiments, as shown in FIGS. 3 and 4, the waste gas treatment assembly 2 further includes a fourth waste gas absorption component 24. The fourth waste gas absorption component 24 is arranged downstream of the third waste gas absorption component 23, and the fourth waste gas absorption component 24 is a waste gas adsorption chamber.

Specifically, the fourth waste gas absorption component 24 is configured for the fourth-stage waste gas absorption. After the first three stages of waste gas absorption treatment, the waste gas concentration is significantly reduced. Then, the waste gas is adsorbed by the waste gas adsorption chamber, so that the discharged gas contains almost no methanol gas. Since the gas to be treated is finally passed through the waste gas adsorption chamber after previous treatment, the concentration of methanol contained therein is low, which greatly extends the service life of adsorption components such as activated carbon and further reduces the production and usage costs of the liquid chromatography-mass spectrometry system.

In this embodiment, the volatile waste gas in the gas to be treated is treated through four-stage waste gas absorption, which, compared with the arrangement of three-stage waste gas absorption, ensures that the volatile waste gas is almost absorbed and that the discharged gas meets the standard; and the waste gas adsorption chamber is more flexible in arrangement position, which is beneficial to improving the compactness of the spatial layout.

Optionally, an adsorption component, such as activated carbon or a molecular sieve, is provided in the waste gas adsorption chamber.

In some embodiments, as shown in FIGS. 3 and 4, the first waste gas absorption component 21 is an atomizer 101, the second waste gas absorption component 22 is a condenser 102, the third waste gas absorption component 23 is a spray tower 103, and the fourth waste gas absorption component 24 is provided with activated carbon 104.

Specifically, the atomizer 101 delivers a large number of atomized droplets into the gas to be treated, and the atomized droplets are mixed with the methanol gas in the gas to be treated to absorb the methanol gas. The atomized droplets absorbing methanol and the remaining gas then enter the condenser 102 for condensation. After the temperature is reduced, the condensed and accumulated small droplets may continuously absorb the methanol gas in the condenser 102. The remaining methanol gas with a lower concentration then passes through the spray tower 103 where the methanol gas is further absorbed by the spray water. At this time, the methanol has a concentration that has basically met the national emission standard and is finally adsorbed by the activated carbon 104. This ensures that the discharged gas is basically clean air, has no impact on the human body, and ensures a safe and healthy working environment in the laboratory department.

In this embodiment, the waste gas treatment module 400 uses various treatment methods such as atomized droplet absorption, condensed droplet absorption, spray droplet absorption, and activated carbon adsorption. The miniaturized waste gas treatment module 400 is capable of absorbing and removing the volatile waste gas in the gas to be treated, and then discharging clean gas to the outside of the device. This improves the use safety of the liquid chromatography-mass spectrometry system, ensures the cleanliness of the laboratory environment, and reduces the production and usage costs of the liquid chromatography-mass spectrometry system.

Optionally, when generating a waste gas treatment instruction based on the waste gas-related information, the control module 500 controls the atomizer 101, the condenser 102, and the spray tower 103 to initiate waste gas treatment simultaneously, or first controls the upstream waste gas absorption component to initiate waste gas treatment, and then controls the downstream waste gas absorption component to initiate waste gas treatment. For example, the atomizer 101 is first activated to deliver atomized droplets to the waste gas reaching the atomizer 101, and then the condenser 102 is controlled to perform condensation and the spray tower 103 is controlled to supply spray water within a period of time.

Optionally, the activated carbon 104 may be mounted adjacent to the vent port 3 of the waste liquid discharge assembly 4 to further reduce the waste gas concentration.

In some embodiments, as shown in FIG. 3, the waste liquid discharge assembly 4 includes a discharge line 41, a waste liquid pump 42, and a waste liquid cell 43. The discharge line 41 is configured to enable the waste liquid pump 42 to be in fluid communication with the condenser 102 as the second waste gas absorption component 22 and the spray tower 103 as the third waste gas absorption component 23. The waste liquid pump 42 is configured to aspirate the waste liquid generated by the condenser 102 and the spray tower 103 via the discharge line 41, and the waste liquid cell 43 is configured to store the waste liquid aspirated by the waste liquid pump 42.

In this embodiment, the waste liquid generated by the condenser 102 and the spray tower 103 is aspirated by means of the waste liquid pump 42, so that the saturated waste liquid containing waste gas in the condenser 102 and the spray tower 103 is promptly transferred, which avoids the impact on the liquefaction and absorption efficiency of the condenser 102 or the spray tower 103 for the waste gas due to the accumulation of the waste liquid.

Optionally, the waste liquid cell 43 is in fluid communication with a medical waste liquid channel.

In some embodiments, as shown in FIGS. 3 and 4, the waste gas treatment assembly 2 includes at least one atomizer 101 or one spray tower 103, for example, one of the first waste gas absorption component 21, the second waste gas absorption component 22 and the third waste gas absorption component 23 is an atomizer 101 or a spray tower 103. Here, the liquid chromatography-mass spectrometry system further includes a water supply device 5 configured to at least supply water to the atomizer 101 or the spray tower 103.

In some implementations, one of the first waste gas absorption component 21, the second waste gas absorption component 22 and the third waste gas absorption component 23 is an atomizer 101, and one is a spray tower 103. Here, the same water supply device 5 is used to supply water to the atomizer 101 and the spray tower 103.

In some other implementations, two water supply devices 5 may also be provided to supply water to the atomizer 101 and the spray tower 103, respectively.

In some embodiments, as shown in FIG. 3, the waste gas treatment assembly 2 includes at least one spray tower 103, for example, one of the first waste gas absorption component 21, the second waste gas absorption component 22 and the third waste gas absorption component 23 is a spray tower 103. The water supply device 5 is configured to at least supply water to the spray tower 103 and includes a water supply source 50, a water supply line 51, and a circulating water line 52. The water supply source 50 is configured to supply water. The water supply line 51 provides fluid communication between the water supply source 50 and the spray tower 103. A first switching component 511 and a water pump 512 are provided on the water supply line 51. The first switching component 511 is configured to control ON and OFF of the water supply line 51, and the water pump 512 is located downstream of the first switching component 511 and configured to aspirate the water supplied by the water supply source 50 to the spray tower 103 through the water supply line 51. One end of the circulating water line 52 is in fluid communication with the water supply line 51 between the first switching component 511 and the water pump 512, and the other end of the circulating water line 52 is in fluid communication with the spray tower 103. A second switching component 522 is provided on the circulating water line 52, and the second switching component 522 is configured to control ON and OFF of the circulating water line 52.

Specifically, as shown in FIGS. 3 and 5, the water supply line 51 provides fluid communication between the water supply source 50 and the fourth opening 134, the circulating water line 52 provides fluid communication between the fifth opening 135 and the water supply line 51, and the part of the circulating water line 52 in fluid communication with the water supply line 51 is located between the first switching component 511 and the water pump 512. When the water supply line 51 is in fluid communication with the water supply source 50 by means of the first switching component 511, and the second switching component 522 disconnects the circulating water line 52 from the water supply line 51, the water pump 512 aspirates the water from the water supply source 50 to the fourth opening 134 through the water supply line 51 to supply spray water to the spray tower 103. When the first switching component 511 disconnects the water supply line 51 from the water supply source 50, and the circulating water line 52 is in fluid communication with the water supply line 51 by means of the second switching component 522, the water pump 512 aspirates the water in the spray tower 103 from the fifth opening 135 to the fourth opening 134 via the circulating water line 52 to recycle the spray water.

In this embodiment, the water supply device 5 supplies spray water to the spray tower 103 so as to continuously supply spray water droplets for absorbing waste gas. The water supply device 5 is also capable of achieving circulating water spray of the spray tower 103, thereby reducing the water consumption of the spray tower 103.

Optionally, the water supply source 50 may be a water pipe, a water tank, a water tower, or the like. Optionally, both the first switching component 511 and the second switching component 522 may be electromagnetic on-off valves or the like.

Optionally, the water supply source 50 may directly supply water and cyclically supply water simultaneously or independently. For example, the water supply source 50 first supplies water, then the first switching component 511 is disconnected, the second switching component 522 is connected, and then the cyclic water supply is performed. The direct water supply and the cyclic water supply are carried out alternately. Optionally, the spray tower 103 may preset the number of cycles for cyclic water supply.

In some embodiments, as shown in FIGS. 3 and 4, the waste gas treatment module 400 further includes a bypass line 6 and a third switching component 63. The bypass line 6 is arranged downstream of the aspiration assembly 1 and upstream of the vent port 3 of the liquid chromatography-mass spectrometry system. The vent port 3 is configured to discharge the aspirated gas to be treated or the gas treated by the waste gas treatment module 400. The third switching component 63 is configured to switch between a first state and a second state. When the third switching component 63 is in the first state, the aspiration assembly 1 is connected to the waste gas treatment assembly 2, and the aspiration assembly 1 is disconnected from the bypass line 6. When the third switching component 63 is in the second state, the aspiration assembly 1 is connected to the bypass line 6, and the aspiration assembly 1 is disconnected from the waste gas treatment assembly 2.

Specifically, the third switching component 63 is arranged upstream of the waste gas treatment assembly 2, the bypass line 6 provides fluid communication between the third switching component 63 and the vent port 3, and the vent port 3 is arranged downstream of the waste gas treatment assembly 2. When waste gas absorption is required, for example, when the waste gas concentration does not meet the standard or a continuous operating duration of the liquid chromatography-mass spectrometry system is greater than a preset duration, the third switching component 63 switches to the first state, and the aspiration port 10 is connected to the waste gas treatment assembly 2; and when waste gas absorption is not required, for example, when the waste gas concentration meets the standard or the continuous operating duration of the liquid chromatography-mass spectrometry system is not greater than the preset duration, the third switching component 63 switches to the second state, and the aspiration port 10 is connected to the bypass line 6.

In this embodiment, a flow path of the gas to be treated is controlled by means of the third switching component 63, so that the gas to be treated flows through the waste gas treatment assembly 2 when waste gas absorption is required, and flows through the bypass line 6 for direct discharge when waste gas absorption is not required, such as when the first waste gas concentration is not greater than the first preset concentration. This might specifically purify the gas to be treated, thereby reducing the energy consumption of the waste gas treatment assembly 2, such as reducing water consumption and power consumption, and further reducing the usage cost of the liquid chromatography-mass spectrometry system.

Optionally, the third switching component 63 may be an electromagnetic directional valve or the like.

In some embodiments, the first waste gas concentration measurement component 71 is configured to measure the first waste gas concentration of the gas to be treated to determine whether the third switching component 63 is to switch to the first state or the second state. The third switching component 63 is configured to switch to the first state when the first waste gas concentration is greater than the first preset concentration, and switch to the second state when the first waste gas concentration is not greater than the first preset concentration.

For example, the first waste gas concentration measurement component 71 may be arranged between the aspiration port 10 and the third switching component 63. The first preset concentration may be set to a national standard threshold (e.g., 50 mg/m³). If the waste gas concentration does not meet the national standard, the waste gas needs to be absorbed and treated by means of the waste gas treatment assembly 2; and if the waste gas concentration meets the national standard, the waste gas can be directly discharged.

In this embodiment, the first waste gas concentration measurement component 71 measures the first waste gas concentration to determine the state of the third switching component 63, so that the gas to be treated automatically flows through the bypass line 6 for direct discharge when the waste gas concentration is low. This allows the volatile waste gas to be specifically absorbed, thereby reducing energy consumption, reducing the usage cost of the liquid chromatography-mass spectrometry system, and improving the automation level of the liquid chromatography-mass spectrometry system.

In some embodiments, as shown in FIGS. 3 and 4, the liquid chromatography-mass spectrometry system further includes a vent valve 73 arranged between the second waste gas concentration measurement component 72 and the vent port 3 of the liquid chromatography-mass spectrometry system. The vent valve 73 is configured to open when the second waste gas concentration is not greater than the second preset concentration to discharge the treated gas via the vent port 3.

Specifically, the second waste gas concentration measurement component 72 is arranged between the waste gas treatment assembly 2 and the vent port 3. The second preset concentration may be set to a national standard threshold. The vent valve 73 is opened only when the waste gas concentration meets the national standard, which avoids environmental pollution by waste gas, thereby improving the use safety of the liquid chromatography-mass spectrometry system.

Optionally, the bypass line 6 may provide fluid communication between the third switching component 63 and the second waste gas concentration measurement component 72, which can implement dual measurement of the waste gas concentration, thereby improving the reliability of measurement results. The bypass line 6 may provide fluid communication between the third switching component 63 and the vent port 3. Optionally, the second preset concentration may be different from the first preset concentration or the same as the first preset concentration, for example, both are set to a national allowable emission standard value (e.g., 50 mg/m³).

In some embodiments, as shown in FIG. 4, the waste gas treatment module 400 further includes a reprocessing line 9. A first end of the reprocessing line 9 is arranged between the second waste gas concentration measurement component 72 and the vent valve 73, a second end of the reprocessing line is arranged between the third switching component 63 and the waste gas treatment assembly 2, and a fourth switching component 74 is provided on the reprocessing line. During normal operation of the system, the fourth switching component 74 disconnects the reprocessing line 9. When the second waste gas concentration does not meet the standard, the vent valve 73 is closed, the fourth switching component 74 connects the reprocessing line, and the gas that does not meet the standard is directed to the waste gas treatment assembly 2 again for re-liquefaction and re-absorption until the second waste gas concentration meets the standard.

Optionally, the fourth switching component 74 may be an electromagnetic on-off valve or the like.

In some embodiments, as shown in FIGS. 3 and 4, the aspiration assembly 1 further includes a filter component 81 and a fan 82. The filter component 81 is arranged downstream of the aspiration port 10 and configured to filter particulate matters in the gas to be treated. The fan 82 is arranged between the filter component 81 and the waste gas treatment assembly 2 and configured to create a negative pressure for aspirating the gas to be treated when receiving the waste gas treatment instruction.

In this embodiment, the aspiration assembly 1 is provided with the filter component 81 in front of the fan 82, which filters the gas to be treated that enters the fan 82 to prevent particulate impurities from entering an air duct of the fan 82 and thus causing blockage.

Optionally, the filter component 81 may be a filter screen or the like.

In some embodiments, as shown in FIGS. 3 and 4, the waste gas treatment module 400 further includes a flow regulation component 83 arranged downstream of the aspiration port 10 and configured to regulate a gas flow rate.

Optionally, three flow regulation components 83 are provided. The three flow regulation components 83 are in one-to-one correspondence with the three aspiration ports. Optionally, the flow regulation component 83 may be set to different opening degrees or damping according to different generation rates of the volatile waste gas of each module, and the aspiration effect is optimized by adjusting the aspiration flow rate.

In some embodiments, at least one of the pretreatment module 100, the liquid chromatography module 200 and the mass spectrometry module 300 is arranged in a housing, for example, the mass spectrometry module 300 is arranged in the housing. At least a portion of the waste gas treatment module 400 is arranged in the housing, for example, at least the waste gas treatment assembly 2 is arranged in the housing. Due to the design of at least two-stage waste gas absorption of the waste gas treatment module 400, the waste gas treatment module 400, especially the waste gas treatment assembly 2, may be compactly arranged in the liquid chromatography-mass spectrometry system.

In some embodiments, the mass spectrometry module 300 and the waste gas treatment assembly 2 are arranged in one housing, and the aspiration assembly 1 is configured to aspirate waste gas from the pretreatment module 100, the liquid chromatography module 200 and the mass spectrometry module 300 into the waste gas treatment assembly 2 for waste gas treatment.

In some other embodiments, a portion of the waste gas treatment module 400 may be arranged in the liquid chromatography-mass spectrometry system, and another portion may be arranged outside the liquid chromatography-mass spectrometry system, such as a waste liquid cell.

In some embodiments, at least a portion of the waste gas treatment module 400 is in fluid communication with at least one of the pretreatment module 100, the liquid chromatography module 200 and the mass spectrometry module 300 in modular manner, for example, at least the waste gas treatment assembly 2 is in fluid communication with at least one of the pretreatment module 100, the liquid chromatography module 200 and the mass spectrometry module 300 in modular manner. The modular design of the waste gas treatment module 400 facilitates the connection of the miniaturized waste gas treatment module 400 to the liquid chromatography-mass spectrometry system, so that the waste gas treatment of the liquid chromatography-mass spectrometry system is no longer limited to specific laboratory department, and the production cost of equipment manufacturers and the usage cost of the laboratory department might be reduced.

The liquid chromatography-mass spectrometry system provided in the disclosure has been described in detail above. Specific embodiments are used herein to explain the principles and implementation of the disclosure, and the above description of the embodiments is merely used to facilitate understanding of the method of the disclosure and the core concept thereof. It should be noted that for those of ordinary skill in the art, numerous improvements and modifications may also be made to the disclosure without departing from the principles of the disclosure. Such improvements and modifications also fall within the scope of protection of the appended claims of the disclosure.

1. A liquid chromatography-mass spectrometry system, comprising:
a pretreatment module configured to pretreat a test sample using a pretreatment reagent;
a liquid chromatography module configured to elute the pretreated test sample using an eluent;
a mass spectrometry module configured to perform mass spectrometry on the eluted test sample, at least one of the pretreatment module, the liquid chromatography module and the mass spectrometry module being arranged in a housing;
a waste gas treatment module, at least a portion of the waste gas treatment module being arranged in the housing, and the waste gas treatment module being in fluid communication with at least one of the pretreatment module, the liquid chromatography module and the mass spectrometry module and being configured to perform liquefaction and absorption of a volatile waste gas in a gas to be treated that is generated by at least one of the pretreatment reagent, the eluent and the eluted test sample; and
a control module configured to generate a waste gas treatment instruction based on waste gas-related information and to control the waste gas treatment module to initiate waste gas treatment on the gas to be treated in response to the waste gas treatment instruction, so as to discharge the treated gas from the liquid chromatography-mass spectrometry system.

2. The liquid chromatography-mass spectrometry system according to claim 1, further comprising a first waste gas concentration measurement component configured to measure a first waste gas concentration of the gas to be treated; and
the control module (500) is further configured to obtain the first waste gas concentration as the waste gas-related information and to generate the waste gas treatment instruction when the first waste gas concentration is greater than a first preset concentration.

3. The liquid chromatography-mass spectrometry system according to claim 1, wherein the control module is further configured to obtain a sample test volume of the liquid chromatography-mass spectrometry system as the waste gas-related information and to generate the waste gas treatment instruction when the sample test volume is greater than a preset test volume.

4. The liquid chromatography-mass spectrometry system according to claim 1, further comprising:
a second waste gas concentration measurement component arranged downstream of the waste gas treatment module and configured to measure a second waste gas concentration of the treated gas;
wherein the control module is further configured to control the waste gas treatment module to discharge the treated gas when the second waste gas concentration is not greater than a second preset concentration.

5. The liquid chromatography-mass spectrometry system according to claim 4, wherein the control module is further configured to control the waste gas treatment module to perform re-liquefaction and re-absorption of the volatile waste gas in the treated gas when the second waste gas concentration is greater than the second preset concentration.

6. The liquid chromatography-mass spectrometry system according to claim 1, wherein the waste gas treatment module comprises:
an aspiration assembly in fluid communication with at least one of the pretreatment module (100), the liquid chromatography module and the mass spectrometry module and configured to aspirate the gas to be treated that is generated by the module(s) in fluid communication with the aspiration assembly;
a waste gas treatment assembly arranged downstream of the aspiration assembly and configured to perform liquefaction and absorption of the volatile waste gas in the aspirated gas to be treated to generate a waste liquid, the waste gas treatment assembly comprising a first waste gas absorption component and a second waste gas absorption component, the second waste gas absorption component being arranged downstream of the first waste gas absorption component; and
a waste liquid discharge assembly configured to discharge the waste liquid.

7. The liquid chromatography-mass spectrometry system according to claim 6, wherein the first waste gas absorption component and the second waste gas absorption component each comprise one of an atomizer, a condenser and a spray tower, the atomizer being configured to generate atomized droplets for absorbing the waste gas, the condenser being configured to condense droplets in the gas, and the spray tower being configured to provide spray droplets for absorbing the waste gas and generating the waste liquid.

8. The liquid chromatography-mass spectrometry system according to claim 7, wherein the first waste gas absorption component is an atomizer, and the second waste gas absorption component is a condenser; or
both the first waste gas absorption component and the second waste gas absorption component are spray towers.

9. The liquid chromatography-mass spectrometry system according to claim 7, wherein the waste gas treatment assembly further comprises a third waste gas absorption component, the third waste gas absorption component being arranged downstream of the second waste gas absorption component, and the third waste gas absorption component being one of a condenser, a spray tower and a waste gas adsorption chamber.

10. The liquid chromatography-mass spectrometry system according to claim 9, wherein the waste gas treatment assembly further comprises a fourth waste gas absorption component, the fourth waste gas absorption component being arranged downstream of the third waste gas absorption component, and the fourth waste gas absorption component being a waste gas adsorption chamber.

11. The liquid chromatography-mass spectrometry system according to claim 10, wherein the first waste gas absorption component is the atomizer the second waste gas absorption component is the condenser, the third waste gas absorption component is the spray tower, and the fourth waste gas absorption component is provided with activated carbon; and
the waste liquid discharge assembly comprises a discharge line, a waste liquid pump, and a waste liquid cell, the discharge line being configured to enable the waste liquid pump to be in fluid communication with the condenser and the spray tower, the waste liquid pump being configured to aspirate a waste liquid generated by the condenser and the spray tower via the discharge line, and the waste liquid cell being configured to store the waste liquid aspirated by the waste liquid pump.

12. The liquid chromatography-mass spectrometry system according to claim 7, wherein the waste gas treatment assembly comprises at least one atomizer or one spray tower; and
the liquid chromatography-mass spectrometry system further comprises a water supply device configured to at least supply water to the atomizer or the spray tower.

13. The liquid chromatography-mass spectrometry system according to claim 12, wherein the waste gas treatment assembly comprises at least one spray tower, wherein the water supply device is configured to at least supply water to the spray tower and comprises:
a water supply source configured to supply the water;
a water supply line that provides fluid communication between the water supply source and the spray tower, a first switching component and a water pump being provided on the water supply line, the first switching component being configured to control ON and OFF of the water supply line, and the water pump being located downstream of the first switching component and configured to aspirate the water supplied by the water supply source to the spray tower through the water supply line; and
a circulating water line, one end of the circulating water line being in fluid communication with the water supply line between the first switching component and the water pump, the other end of the circulating water line being in fluid communication with the spray tower, a second switching component being provided on the circulating water line, and the second switching component being configured to control ON and OFF of the circulating water line.

14. The liquid chromatography-mass spectrometry system according to claim 6, further comprising:
a bypass line arranged downstream of the aspiration assembly and upstream of a vent port of the liquid chromatography-mass spectrometry system, the vent port being configured to discharge the aspirated gas to be treated or the gas treated by the waste gas treatment module; and
a third switching component configured to switch between a first state, in which the aspiration assembly is connected to the waste gas treatment assembly and the aspiration assembly is disconnected from the bypass line, and a second state, in which the aspiration assembly is connected to the bypass line and the aspiration assembly is disconnected from the waste gas treatment assembly.

15. The liquid chromatography-mass spectrometry system according to claim 14, further comprising:
a first waste gas concentration measurement component configured to measure a first waste gas concentration of the gas to be treated so as to determine whether the third switching component is to switch to the first state or the second state, wherein the third switching component is configured to switch to the first state when the first waste gas concentration is greater than a first preset concentration, and to switch to the second state when the first waste gas concentration is not greater than the first preset concentration.

16. The liquid chromatography-mass spectrometry system according to claim 6, wherein the aspiration assembly comprises:
aspiration ports;
a filter component arranged downstream of the aspiration ports and configured to filter particulate matters in the gas to be treated; and
a fan arranged between the filter component and the waste gas treatment assembly and configured to create a negative pressure for aspirating the gas to be treated.

17. The liquid chromatography-mass spectrometry system according to claim 16, wherein the aspiration ports comprise a first aspiration port, a second aspiration port, and a third aspiration port, the first aspiration port being in fluid communication with the pretreatment module, the second aspiration port being in fluid communication with the liquid chromatography module, and the third aspiration port being in fluid communication with the mass spectrometry module.

18. The liquid chromatography-mass spectrometry system according to claim 17, wherein the first aspiration port is arranged adjacent to at least one of a cleaning cell, a reagent disc and a waste box of the pretreatment module; and/or
the second aspiration port is arranged adjacent to at least one of a reaction cell and a cleaning cell of the liquid chromatography module; and/or
the third aspiration port is arranged at a vacuum exhaust outlet of the mass spectrometry module.

19. The liquid chromatography-mass spectrometry system according to claim 6, wherein the mass spectrometry module is arranged in the housing, and the waste gas treatment assembly is arranged in the housing.

20. The liquid chromatography-mass spectrometry system according to claim 6, wherein the waste gas treatment assembly is in fluid communication with at least one of the pretreatment module, the liquid chromatography module and the mass spectrometry module in modular manner.
